(19) United States
(12) Patent Application Publication
(10) Pub. No.: US 2018/0128422 A1
(43) Pub. Date: May 10, 2018

(54) Ultimate camera mount

(71) Applicant: Dennis Jasko, Topeka, KS (US)

(72) Inventor: Dennis Jasko, Topeka, KS (US)

(21) Appl. No.: 15/732,119

(22) Filed: Sep. 20, 2017

Related U.S. Application Data
(60) Provisional application No. 62/495,884, filed on Sep. 28, 2016.

(51) Int. Cl. F16M 13/02; G03B 17/56

(52) U.S. Cl. CPC F16M 13/022; F16M 2200/022; G03B 17/561

(57) ABSTRACT

The Ultimate Camera Mount is a device that is a universal camera mount. The bodies are made of aluminum. They can also be made of steel, carbon, carbon steel, stainless steel or plastic. These bodies are made of ½″ aluminum. The measurements can vary from ¼ inch in circumference up to 2 inches in circumference. They can be made of round, square, angle or octagon material. The screw components are made with stainless steel screws and a hanger bolt. The bolts can also be a component of zinc, steel and galvanize. There are 2 bodies to this device that can be made of lengths of ½ inch long up to 2 feet long. This device is designed to mount different types of cameras that attach to any tree, wood or house. It is designed to screw into wood to hang your camera to. You can adjust it from 1 to 360 degrees.

The ultimate camera mount is composed of 2 aluminum bodies that are 2″ in length by ½″ circumference. Both aluminum bodies are exactly the same. The 2″ bodies have 1/4×20 threaded into the center of the ½″ body one-inch deep. On the back side of the threaded insert aluminum body it has a cutout that measures ¼″ deep by ½″ in length to be able to connect the 2 bodies together to make it one uniform piece. The other side of the aluminum ½″ round by 2″ in length body has a notch which measures 1/16″ deep by ½″ long that allows a 10/24 thread button head screw and 10/24 thread wingnut to tighten them to make it a uniform surface on both sides as well as to make the two bodies pivot. It has a hole drilled through it to fit a 10/24 thread×1″ button head screw. The second end of the aluminum body has a ¼×20×2″ hanger bolt with a ¼×20 jam nut on the end of the thread. The ¼×20 thread on the hanger bolt screws into the threaded body 1″ deep. The other side of the hanger bolt with the lag thread then screws into the wood. The ¼×20 thread has permanent loctite into the body as well as permanent loctite between the ¼×20 jam nut and the aluminum body. The jam nut then is tightened into the aluminum body solid so that it won't back out from the aluminum body. The second aluminum body has a ¼×20×2″ long all thread. This all thread is permanent loctited into the second body 1″ deep into the center of the body. This all thread has a ¼×20 wingnut that is placed upside down to secure the camera in place. The 10/24×1″ button head screw connects the 2 bodies together with a 10/24 wingnut that tightens the two pieces together. With this, as you mount the camera onto the ¼×20 all thread it allows you to rotate a camera 360 degrees. The 10/24 screw and wingnut that connects the 2 bodies together allows this device to adjust up to 290 degrees.

The Ultimate Camera Mount is a device that is a universal camera mount. The bodies are made of aluminum. They can also be made of steel, carbon, carbon steel, stainless steel or plastic. These bodies are made of ½″ aluminum. The measurements can vary from ¼ inch in circumference up to 2 inches in circumference. They can be made of round, square, angle or octagon material. The screw components are made with stainless steel screws and a hanger bolt. The bolts can also be a component of zinc, steel and galvanize. There are 2 bodies to this device that can be made of lengths of ½ inch long up to 2 feet long. This device is designed to mount different types of cameras that attach to any tree, wood or house. It is designed to screw into wood to hang your camera to. You can adjust it from 1 to 360 degrees.

### SKETCH DESCRIPTIONS

FIG. 1
1. Wingnut—¼×20 thread
2. All thread—¼×20 thread×2″ in length
3. Body #1—½×2″ aluminum
4. Button head screw— 10/24 thread×3/4″
5. Wingnut— 10/24 thread
6. Body #2—½×2″ aluminum
7. Nut—¼×20 thread
8. Hanger bolt—¼×20 thread by 2″ in length

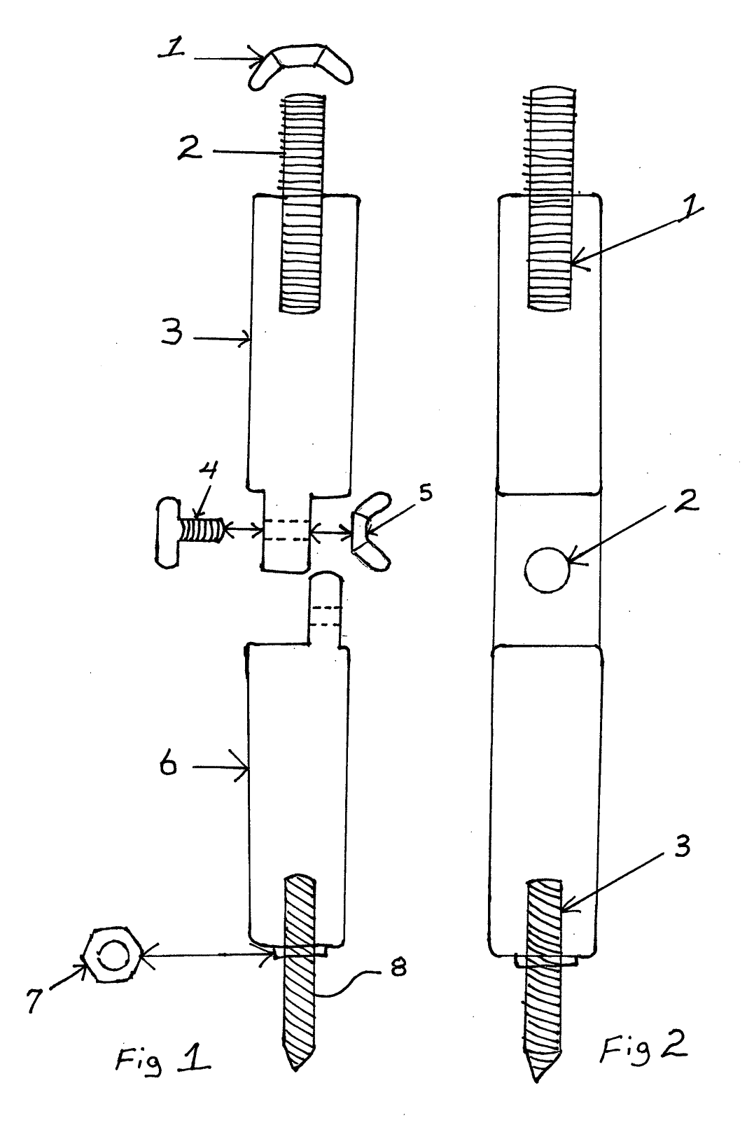

FIG. 2

Top view and inside view of camera mount
1. All thread ¼×20 tapped into the body 1″
2. Hole to fit 10/24 button head screw
3. Hanger bolt ¼×20 thread tapped into the body 1″

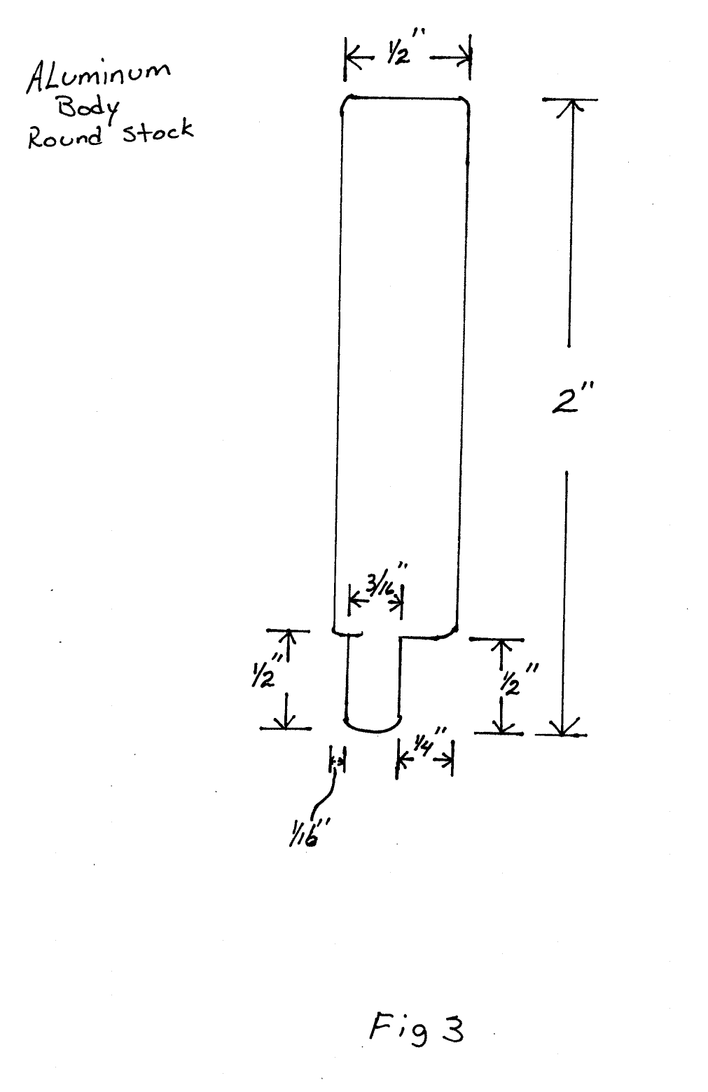

FIG. 3

Round stock aluminum body dimensions

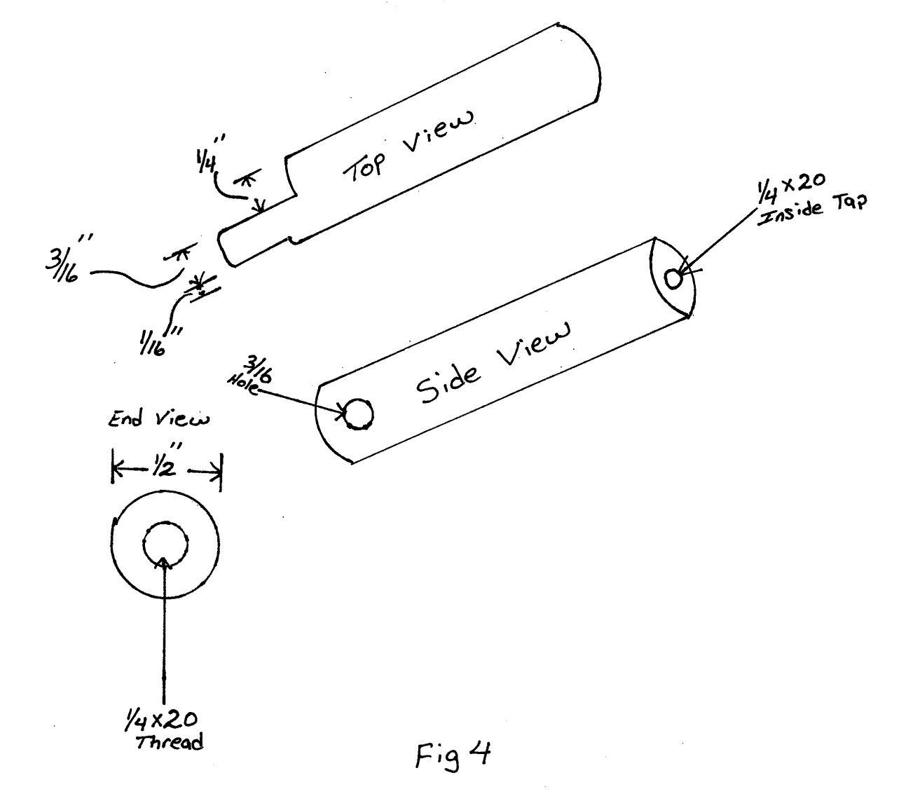

FIG. 4

Top, side and end view of the bodies

1. A camera mounting device that is a two-piece body which allows you to screw into wood with one part of the body. In the center of the mount it pivots so that it allows you to adjust in different directions to position the camera to contour to leaning trees etc. The second part of the body has a thread which allows you to screw your camera to it and this will give you a 360-degree turning radius to adjust your camera. The wingnut on the top of the thread allows you to tighten the camera down.
